(19) United States
(12) Patent Application Publication
(10) Pub. No.: US 2018/0045137 A1
(43) Pub. Date: Feb. 15, 2018

(54) INTERNAL COMBUSTION ENGINE PISTON HAVING COOLING GALLERY STRUCTURE AND INTERNAL COMBUSTION ENGINE

(71) Applicant: BINZHOU BOHAI PISTON CO., LTD., Binzhou, Shandong (CN)

(72) Inventors: Fenghua LIN, Binzhou, Shandong (CN); Guohua ZHANG, Binzhou, Shandong (CN); Shiying LIU, Binzhou, Shandong (CN); Xuejun MA, Binzhou, Shandong (CN); Jian ZHANG, Binzhou, Shandong (CN); Hongfeng ZHANG, Binzhou, Shandong (CN); Tao LIU, Binzhou, Shandong (CN); Yilin ZHANG, Binzhou, Shandong (CN); Shili WANG, Binzhou, Shandong (CN)

(73) Assignee: BINZHOU BOHAI PISTON CO., LTD., Binzhou, Shandong (CN)

(21) Appl. No.: 15/550,904

(22) PCT Filed: Apr. 3, 2015
(86) PCT No.: PCT/CN2015/075869

§ 371 Date: Aug. 14, 2017

(30) Foreign Application Priority Data
Feb. 16, 2015 (CN) 201510084881.4

(51) Int. Cl. F02F 3/00; F02F 3/18

(52) U.S. Cl. CPC F02F 3/003; F02F 3/18; F02F 2003/0061

(57) ABSTRACT

An internal combustion engine piston having an internal cooling cavity structure is provided, which includes a piston body, and a ring body fitted with the piston body to form the internal cooling cavity structure. The ring body and the top of the piston body form a first fitting region, and the ring body and a top end of a skirt portion of the piston body form a second fitting region. The first fitting region includes a body fitting portion and a ring body fitting portion arranged at the top of the ring body. Compared with the conventional technology, the ring body welding cylindrical surface in the present application is fitted with the body welding cylinder surface, and the welding seam formed by the welding does not extend into the cooling cavity.

This application claims the priority to Chinese Patent Application No. 201510084881.4 titled “INTERNAL COMBUSTION ENGINE PISTON HAVING INTERNAL COOLING CAVITY STRUCTURE AND INTERNAL COMBUSTION ENGINE”, filed with the Chinese State Intellectual Property Office on Feb. 16, 2015, the entire disclosure of which is incorporated herein by reference.

### FIELD

The present application relates to the technical field of internal combustion engine manufacturing, and more particularly to an internal combustion engine piston having an internal cooling cavity structure and an internal combustion engine.

### BACKGROUND

In recent years, more strengthened and more lightened engines generate more and more load to pistons due to increasing pressure and temperature in cylinders. Subsequently, the cooling function and the strength of the material of a piston are more and more important.

At present, the maximum peak cylinder pressure (Max. pcp) in a diesel engine cylinder has exceeded 25 MPa. Aluminum alloy material can no longer meet such a high load bearing requirement. Therefore, manufacturers began to use forged steel and cast iron materials, which have better effects. However, this kind of piston has the following disadvantages: although the forged steel material can withstand a high temperature load, and a high temperature environment will cause the property of lubricating oil to degrade significantly, which increases the friction loss between the piston and the cylinder, and also increases carbon deposition. Thus, it is necessary to provide a cooling cavity inside the piston for enhancing the cooling effect. The forged steel piston with the internal cooling cavity can better meet the requirements of high burst pressure, high temperature working environment.

The manufacturing process of the cooling cavity is the difficulty and key in the manufacturing process of the internal combustion engine piston. Whether the manufacturing process is reasonable can often effect the service life of the piston to a great extent. An internal combustion engine piston having a cooling cavity structure typically includes a piston body and a ring body connected to the piston body in a fitted manner, with the cooling cavity being formed between the ring body and the piston body. In a current internal combustion engine piston, the top of the ring body is connected to the piston body by welding, and an welding surface is a closed cylindrical surface along the axis of the piston. One end of the closed cylindrical surface extends to the top of the piston, and another end extends to the cooling cavity. For the piston with a head having a large thickness, this method is apt to cause a situation of not achieving full penetration weld. If the full penetration weld is ensured, the heat affected area of the head of the piston may be inevitably increased, which may cause bad influence on the deformation of the piston head.

Therefore, a technical issue to be presently addressed by the person skilled in the art is to ensure the welding quality of the ring body with the piston body without increasing the heat affected area of welding.

### SUMMARY

In view of the above, it is an aspect of the present application to provide an internal combustion engine piston having an internal cooling cavity structure, so as to ensure the quality of welding between a ring body and a piston body without increasing the heat affected area by welding.

Another aspect of the present application is to provide an internal combustion engine having the internal combustion engine piston.

In order to achieve the above objects, the following technical solution is provided according to the present application.

An internal combustion engine piston having a cooling cavity structure, includes a piston body and a ring body fitted with the piston body to form the cooling cavity structure. The ring body and the top of the piston body form a first fitting region, and the ring body and a top end of a skirt portion of the piston body form a second fitting region. The first fitting region includes:
a body fitting portion arranged at the top of the piston body, wherein the body fitting portion includes a body welding cylindrical surface extending downwardly from the top of the piston body and a first support protrusion connected to a bottom end of the body welding cylindrical surface and extending in a radial direction of the piston; and
a ring body fitting portion arranged at the top of the ring body, wherein the ring body fitting portion includes a ring body welding cylindrical surface fitted with the body welding cylindrical surface and a first lapping groove configured for receiving the first support protrusion, and the body welding cylindrical surface is connected to the ring body welding cylindrical surface by welding.

Preferably, the second fitting region is a stepped lapping area.

Preferably, the stepped lapping area includes:
a second support protrusion arranged on a bottom surface of the ring body and extending in an axial direction of the piston, specifically, the width of the second support protrusion in the radial direction of the piston is less than a wall thickness of the ring body, and an inner wall of the second support protrusion is flush with an inner wall of the ring body, and
a second lapping groove arranged at a top end of the skirt portion of the piston body and configured for the second support protrusion to be inset therein.

Preferably, the stepped lapping area includes:
a second support protrusion arranged at a top end of the skirt portion of the piston body and extending in an axial direction of the piston, specifically, the width of the second support protrusion in the radial direction of the piston is less than a wall thickness of the top end of the skirt portion, and an inner wall of the second support protrusion is flush with an inner wall of the top end of the skirt portion, and
a second lapping groove provided on a bottom surface of the ring body and configured for receiving the second support protrusion.

Preferably, in the case that the second support protrusion abuts against the second lapping groove, a lapping gap is further presented between the bottom surface of the ring body and the top end of the skirt portion of the piston body.

Preferably, the material of the ring body and the piston body is 42CrMoA.

Preferably, the material of the ring body and the piston body is 38MnVS6.

The internal combustion engine according to the present application, includes a cylinder and a piston provided in the cylinder. The piston is the internal combustion engine piston having the internal cooling cavity structure according to any one of the above aspects.

As can be seen from the above technical solution, in the internal combustion engine piston disclosed in the present application, the ring body and the top of the piston body form a first fitting region. The first fitting region includes the body fitting portion arranged at the top of the piston body, and a ring body fitting portion arranged at the top of the ring body. The body fitting portion is provided with the body welding cylindrical surface extending downwards from the top of the piston body, and the first support protrusion in connection with the bottom end of the body welding cylindrical surface and extending in the radial direction of the piston. The ring body fitting portion includes a ring body welding cylindrical surface configured to be fitted with the body welding cylindrical surface and a first lapping groove configured for receiving the first support protrusion, and the body welding cylindrical surface and the ring body welding cylindrical surface are connected to each other by welding.

Compared with the conventional technology, in the internal combustion engine piston disclosed in the present application, the ring body welding cylindrical surface is fitted with the body welding cylinder surface, and the welding seam formed by the welding has one end extending to the top of the piston and another end extending to a position connected to the first support protrusion rather than extending into the cooling cavity. The connection between the ring body and the piston body is achieved by the combination of welding and lapping. In the case that the thickness of the head of the piston keeps the same, the welding seam in the present application is significantly shortened, such that the full penetration welding can be more easily achieved on the head of the piston, thereby achieving the purpose of effectively ensuring the welding quality of the head of the piston without increasing the heat affected area of the head of the piston.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only some examples of the present application, and for the person skilled in the art, other drawings may be obtained based on these drawings without any creative efforts.

FIG. 1 is a schematic view showing an external structure of an internal combustion engine piston according to an embodiment of the present application;

FIG. 2 is a schematic view showing the fitting of a ring body and a piston body in the internal combustion engine piston according to the embodiment of the present application;

FIG. 3 is a schematic view showing the structure of a semi-finished piston formed after assembly of the ring body and the piston body according to the embodiment of the present application;

FIG. 4 is a schematic view showing the structure of the piston semi-finished product in FIG. 3 after being machined with a ring groove and an oil belt; and

FIG. 5 is a schematic view showing the structure of a second fitting region disclosed in another embodiment of the present application.

### DESCRIPTION OF REFERENCE NUMERALS

| | | | |
|---|---|---|---|
| 1 | ring body, | 2 | piston body, |
| 11 | ring body top surface, | 12 | ring groove, |
| 1-1 | first ring body fitting surface, | 1-2 | second ring body fitting surface, |
| 1-3 | third ring body fitting surface, | 1-4 | fourth ring body fitting surface, |
| 1-5 | fifth ring body fitting surface, | 1-6 | sixth ring body fitting surface, |
| 21 | skirt portion, | 22 | internal cavity, |
| 23 | pin seat, | 24 | piston top, |
| 25 | oil belt, | 2-1 | first body fitting surface, |
| 2-2 | second body fitting surface, | 2-3 | third body fitting surface, |
| 2-4 | fourth body fitting surface, | 2-5 | fifth body fitting surface, |
| 2-6 | sixth body fitting surface, | a | upper half cavity, |
| b | lower half cavity, | c | internal cooling cavity. |

### DETAILED DESCRIPTION

One of the aspects of the present application is to provide an internal combustion engine piston having an internal cooling cavity structure, so as to ensure the quality of welding between a ring body and a piston body without increasing the heat affected area of welding.

Another aspect of the present application is to provide an internal combustion engine having the internal combustion engine piston.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of the present application.

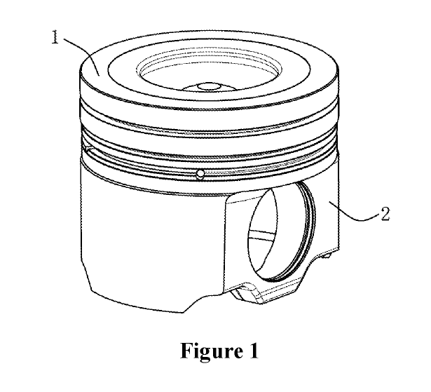

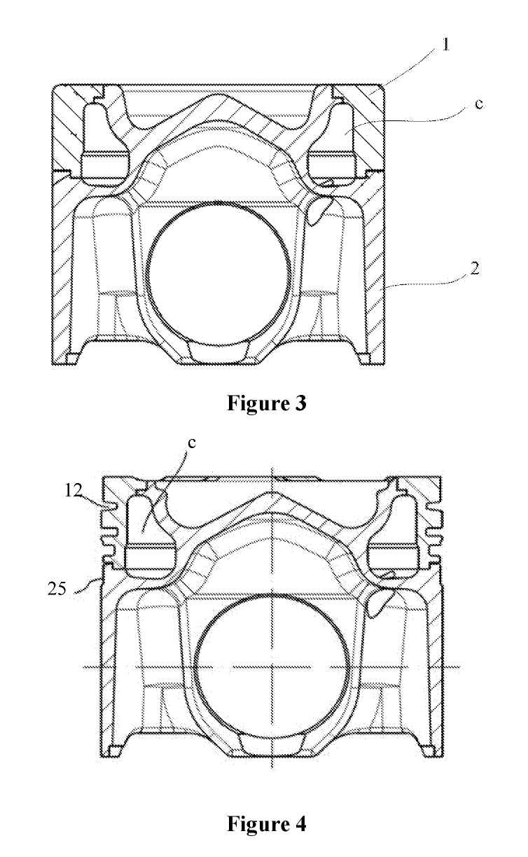

Referring to FIGS. 1 to 5, an internal combustion engine piston having an internal cooling cavity structure according to an embodiment of the present application includes a piston body 2 and a ring body 1, in which the ring body 1 is fitted with the piston body 2 to form the cooling cavity c. There are two contact positions between the ring body 1 and the piston body 2. One of the contact positions is located at the top of the piston body 2, as shown in FIG. 3, and this position is referred to as a first fitting region. The other one of the contact positions is located at a top end of a skirt portion 21 of the piston body 2, and this position is referred to as a second fitting region. The first fitting region includes a body fitting portion arranged at the top of the piston body 2. The body fitting portion specifically includes a body welding cylindrical surface extending downwards from the top of the piston body 2 and a first support protrusion which is in contact with a bottom end of the body welding cylindrical surface and extends in a radial direction of the piston. The first fitting region further includes a ring body fitting portion arranged at the top of the ring body 1, the ring body fitting portion specifically includes a ring body welding cylindrical surface configured to be fitted with the body welding cylindrical surface and a first lapping groove configured for receiving the first support protrusion. The body welding cylindrical surface and the ring body welding cylindrical surface are connected to each other by welding.

In the internal combustion engine piston disclosed in the above embodiment, the ring body welding cylindrical surface is fitted with the body welding cylinder surface, and a welding seam formed by the welding has one end extending to the top of the piston and another end extending to a position connected to the first support protrusion, rather than extending into the cooling cavity c. The connection between the ring body 1 and the piston body 2 is achieved by the combination of welding and lapping. Compared with the conventional technology, in the case that the thickness of a head of the piston keeps the same, the welding seam in the present application is significantly shortened, such that the full penetration welding can be more easily achieved on the head of the piston, thereby effectively ensuring the welding quality of the piston head without increasing the heat affected area of the head of the piston.

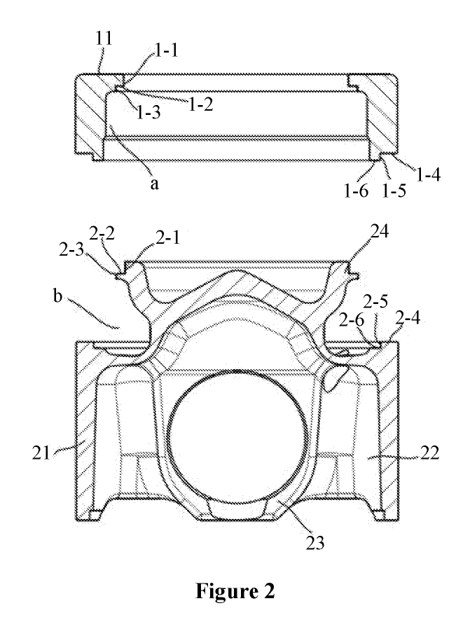

Referring specifically to FIG. 2, in the shown piston body 2, a first body fitting surface 2-1 is just the body welding cylindrical surface in the above embodiment, and the first support protrusion is provided with a second body fitting surface 2-2 and a third body fitting surface 2-3. In the shown ring body 1, a ring body top surface 11 is a planar structure, and a first ring body fitting surface 1-1 is just the ring body welding cylindrical surface in the above embodiment, and a second ring body fitting surface 1-2 and a third ring body fitting surface 1-3 form the first lapping groove in the above embodiment. When the ring body 1 is assembled with the piston body 2, the first support protrusion supports the ring body via the second body fitting surface 2-2. The first body fitting surface 2-1 is connected to the first ring body fitting surface 1-1 by welding. Accordingly, in the first fitting region, the ring body 1 and the piston body 2 are connected by the combination of lapping and welding, and the piston employing this technology only has a shallow ring-shaped welding seam at the top, thus the heat affected area is small, and the welding quality is reliable.

It is to be noted that, in the embodiment according to the present application, there may be a gap fit or an interference fit between the first body fitting surface 2-1 and the first ring body mating surface 1-1, and when the gap fit is employed, the gap value is not greater than 0.05 mm, and when the interference fit is employed, the interference value is not greater than 0.1 mm. There may also be a gap fit or an interference fit between the third body fitting surface 2-3 and the third ring body fitting surface 1-3, and when the gap fit is employed, the gap value is not greater than 0.05 mm, and when the interference fit is employed, the interference value is not greater than 0.1 mm.

As shown in FIG. 2, the total height of the first body fitting surface 2-1 and the third body fitting surface 2-3 is preferably ranging from 4 mm to 40 mm, and the width of the second body fitting surface 2-2 in the radial direction of the piston is preferably not greater than 20 mm.

The second fitting region may be a threaded connection area, a welding area, etc., so long as it ensures that the second fitting region has a high tightness, so that an upper half cavity a in the ring body 1 and a lower half cavity b in the piston body 2 can form an integral internal cooling cavity c. In the embodiment of the present application, the second fitting region is specifically a stepped lapping area, as shown in FIGS. 2 and 3, and the stepped lapping area specifically means that in the second fitting region, the ring body 1 and the piston body 2 are lapped, and in a longitudinal sectional view, the lapping position is in a step shape.

In one embodiment, the lapping area includes, specifically, a second support protrusion and a second lapping groove. Specifically, the second support protrusion is arranged on a bottom surface of the ring body 1 and extends in an axial direction of the piston. The width of the second support protrusion in the radial direction of the piston is less than the wall thickness of the ring body 1, and an inner wall of the second support protrusion is flush with an inner wall of the ring body 1, as shown in FIG. 2, the second lapping groove is arranged at a top end of the skirt portion 21 of the piston body 2 and configured for receiving the second support protrusion.

Referring specifically to FIG. 2, in the shown ring body 1, the second support protrusion has a fifth ring body fitting surface 1-5 and a sixth ring body fitting surface 1-6, and a fourth ring body fitting surface 1-4 is just a bottom surface of the ring body 1. In the shown piston body 2, a fifth body fitting surface 2-5 and a sixth body fitting surface 2-6 form the above second lapping groove, and a fourth body fitting surface 2-4 is just a top surface of the skirt portion 21 of the piston body 2. When the ring body 1 is assembled with the piston body 2, the sixth ring body fitting surface 1-6 of the second support protrusion is contacted with the sixth body fitting surface 2-6 of the piston body 2, so as to form a support to the ring body 1.

When the ring body 1 is assembled with the piston body 2, a lapping gap is presented between the fourth ring body fitting surface 1-4 and the fourth body fitting surface 2-4, and the lapping gap preferably ranges from 0.1 mm to 1 mm, so as to ensure a reliable contact between the second support protrusion and the second lapping groove. There may be a gap fit or an interference fit between the fifth ring body fitting surface 1-5 and the fifth body fitting surface 2-5, and when the gap fit is employed, the gap value is not greater than 0.1 mm, and when the interference fit is employed, the interference value is also not greater than 0.1 mm.

In the above embodiment, the fourth body fitting surface 2-4 and the fifth body fitting surface 2-5 form an outer position-limiting ring, and the second support protrusion is just disposed inside the outer position-limiting ring, as shown in FIGS. 3 and 4. During the operation of the piston, the outer position-limiting ring can effectively resist the deformation of the piston head, thereby effectively reducing the air leakage and oil consumption of the piston during operation.

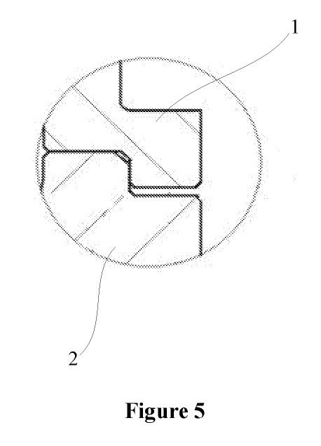

Of course, on the basis of the above-described embodiments, the person skilled in the art can also make a variety of evolutionary variations for the fitting mode of the lapping area. As shown in FIG. 5, another fitting mode of the lapping area is provided. In this embodiment, the second support protrusion is provided at the top end of the skirt portion 21 of the piston body 2 and extends in the axial direction of the piston, and the second lapping groove corresponding the second support protrusion is provided on the bottom surface of the ring body 1. The width of the second support protrusion in the radial direction of the piston is less than a wall thickness of the top end of the skirt portion 21, and an inner wall of the second support protrusion is flush with an inner wall of the top end of the skirt portion 21. When the second support protrusion abuts against the second lapping groove, a lapping gap is further presented between the bottom surface of the ring body 1 and the top end of the skirt portion 21 of the piston body 2.

When the ring body 1 is assembled with the piston body 2, a ring groove 12 is machined on the ring body 1, and an oil belt 25 is machined on the piston body 2, and a combustion chamber structure is machined in a piston top 24.

The internal combustion engine piston having the internal cooling cavity structure disclosed in the present application is a forged steel piston, and the material of the ring body 1 and the piston body 2 is 42CrMoA or 38MnVS6.

As can be seen from the above embodiments, the first fitting region of the internal combustion engine piston disclosed in the present application employs the mode of combination of welding and lapping, which effectively reduces the length of the welding seam at the top of the piston, and achieves the object of improving the welding quality without increasing the heat affected area. The second fitting region employs a fitting mode of directly lapping, which greatly simplifies the manufacturing method of the piston, and may have a significant effect in releasing the residual stress after the assembly of the ring body 1 and the piston body 2 as well as resisting the deformation of the piston land region.

An internal combustion engine is further disclosed in the present application, and the piston in the internal combustion engine is the internal combustion engine piston disclosed in any one of the above embodiments.

Since the internal combustion engine employs the internal combustion engine piston disclosed in the above embodiments, the internal combustion engine also has the above-described corresponding advantages of the internal combustion engine piston, which is not described in this application.

The above embodiments are described in a progressive manner. Each of the embodiments is mainly focused on describing its differences from other embodiments, and references may be made among these embodiments with respect to the same or similar portions among these embodiments.

The description of the embodiments disclosed herein enables the person skilled in the art to implement or use the present application. Various modifications to the embodiments will be apparent to the person skilled in the art, and the general principle herein can be implemented in other embodiments without departing from the spirit or scope of the present application. Therefore, the present application is not limited to the embodiments described herein, but should be in accordance with the widest scope consistent with the principle and novel features disclosed herein.

1. An internal combustion engine piston having an internal cooling cavity structure, comprising:
a piston body, and
a ring body fitted with the piston body to form the internal cooling cavity structure,
wherein the ring body and the top of the piston body form a first fitting region, and the ring body and a top end of a skirt portion of the piston body form a second fitting region,
wherein the first fitting region comprises:
a body fitting portion arranged at the top of the piston body, and the body fitting portion comprises a body welding cylindrical surface extending downwardly from the top of the piston body and a first support protrusion connected to a bottom end of the body welding cylindrical surface and extending in a radial direction of the piston,
a ring body fitting portion arranged at the top of the ring body, and the ring body fitting portion comprises a ring body welding cylindrical surface fitted with the body welding cylindrical surface and a first lapping groove configured for receiving the first support protrusion, and the body welding cylindrical surface is connected to the ring body welding cylindrical surface by welding.

2. The internal combustion engine piston having the internal cooling cavity structure according to claim 1, wherein the second fitting region is a stepped lapping area.

3. The internal combustion engine piston having the internal cooling cavity structure according to claim 2, wherein the stepped lapping area comprises:
a second support protrusion arranged on a bottom surface of the ring body and extending in an axial direction of the piston, wherein the width of the second support protrusion in the radial direction of the piston is less than a wall thickness of the ring body, and an inner wall of the second support protrusion is flush with an inner wall of the ring body, and
a second lapping groove arranged at a top end of the skirt portion of the piston body and configured for receiving the second support protrusion.

4. The internal combustion engine piston having the internal cooling cavity structure according to claim 2, wherein the stepped lapping area comprises:
a second support protrusion arranged at a top end of the skirt portion of the piston body and extending in an axial direction of the piston, wherein the width of the second support protrusion in the radial direction of the piston is less than a wall thickness of the top end of the skirt portion, and an inner wall of the second support protrusion is flush with an inner wall of the top end of the skirt portion, and
a second lapping groove provided on a bottom surface of the ring body and configured for receiving the second support protrusion.

5. The internal combustion engine piston having the internal cooling cavity structure according to claim 3, wherein in the case that the second support protrusion abuts against the second lapping groove, a lapping gap is further presented between the bottom surface of the ring body and the top end of the skirt portion of the piston body.

6. The internal combustion engine piston having the internal cooling cavity structure according to claim 1, wherein the material of the ring body and the piston body is 42CrMoA.

7. The internal combustion engine piston having the internal cooling cavity structure according to claim 1, wherein the material of the ring body and the piston body is 38MnVS6.

8. An internal combustion engine, comprising a cylinder and a piston provided in the cylinder, wherein the piston is the internal combustion engine piston having the internal cooling cavity structure according to claim 1.

9. The internal combustion engine piston having the internal cooling cavity structure according to claim 4, wherein in the case that the second support protrusion abuts against the second lapping groove, a lapping gap is further presented between the bottom surface of the ring body and the top end of the skirt portion of the piston body.

10. An internal combustion engine, comprising a cylinder and a piston provided in the cylinder, wherein the piston is the internal combustion engine piston having the internal cooling cavity structure according to claim 2.

11. An internal combustion engine, comprising a cylinder and a piston provided in the cylinder, wherein the piston is the internal combustion engine piston having the internal cooling cavity structure according to claim 3.

12. An internal combustion engine, comprising a cylinder and a piston provided in the cylinder, wherein the piston is the internal combustion engine piston having the internal cooling cavity structure according to claim 4.

13. An internal combustion engine, comprising a cylinder and a piston provided in the cylinder, wherein the piston is the internal combustion engine piston having the internal cooling cavity structure according to claim 5.

14. An internal combustion engine, comprising a cylinder and a piston provided in the cylinder, wherein the piston is the internal combustion engine piston having the internal cooling cavity structure according to claim 6.

15. An internal combustion engine, comprising a cylinder and a piston provided in the cylinder, wherein the piston is the internal combustion engine piston having the internal cooling cavity structure according to claim 7.

16. An internal combustion engine, comprising a cylinder and a piston provided in the cylinder, wherein the piston is the internal combustion engine piston having the internal cooling cavity structure according to claim 8.

17. An internal combustion engine, comprising a cylinder and a piston provided in the cylinder, wherein the piston is the internal combustion engine piston having the internal cooling cavity structure according to claim 9.
